(19) United States
(12) Patent Application Publication
(10) Pub. No.: US 2022/0136305 A1
(43) Pub. Date: May 5, 2022

(54) TOUCHLESS DOOR OPEN/CLOSE SYSTEM

(71) Applicant: BOBRICK WASHROOM EQUIPMENT, INC., North Hollywood, CA (US)

(72) Inventors: Michael Elwine, Hartlepool (GB); Ben Irvine, Leicester (GB); Chris Samwell, Leicester (GB); Rob Bishop, Leicester (GB)

(21) Appl. No.: 17/217,889

(22) Filed: Mar. 30, 2021

Related U.S. Application Data
(60) Provisional application No. 63/109,785, filed on Nov. 4, 2020.

(51) Int. Cl. E05F 15/614; E05B 47/02; E05B 47/00

(52) U.S. Cl. CPC E05F 15/614; E05B 47/026; E05Y 2900/132; E05Y 2400/42; E05Y 2400/856; E05Y 2201/72; E05B 2047/0068; E05Y 2900/112; E05Y 2600/45

(57) ABSTRACT

A touchless stall door opening and closing system includes a motor, a door pivot for pivoting a door between an open position and a closed position, a locking mechanism for locking the door when the door is in the closed position, and a microcontroller for receiving a signal from a first sensor to drive the motor for opening the door and for receiving a signal from a second sensor for actuating the locking mechanism for unlocking the door. A method for touchless operation of the door includes touchless opening of the door, touchless closing of the door, and touchless locking and unlocking of the door.

### CROSS-REFERENCE TO RELATED APPLICATION

This patent application claims the benefits of U.S. Provisional Patent Application Ser. No. 63/109,785, filed on Nov. 4, 2020, and entitled “TOUCHLESS DOOR OPEN/CLOSE SYSTEM” the entire content of which is hereby incorporated by reference in its entirety.

### BACKGROUND OF THE INVENTION

Germs often are harbored on surfaces used by people. One such surface is a surface of a handle or other means used to open and close doors of bathroom stalls, office cubicles as well as other public rooms in general. Thus, a system is desired that would allow people to enter, lock and exit such stalls, cubicles and rooms without touching the entrance door.

### SUMMARY OF THE INVENTION

In an example embodiment a touchless stall door opening and closing system is provided. The system includes a motor, a door pivot for pivoting a door between an open position and a closed position, and a gear assembly including, a first gear coupled to the motor, and a second gear for driving the door pivot and coupled to the first gear. The motor is for driving the first gear which drives the second gear for driving the door pivot for opening and closing a door. The system also includes a locking mechanism for locking the door when the door is in the closed position, a first sensor, a second sensor, and a microcontroller for receiving a signal from the first sensor to drive the motor for opening the door and for receiving a signal from the second sensor for actuating the locking mechanism for unlocking the door. In one example embodiment, the first gear and the second gear are bevel gears, and the first gear rotates about a first axis and the second gear rotates about a second axis which is perpendicular to the first axis. In another example embodiment, the system also includes a dampener coupled to the door pivot. In yet another example embodiment, the locking mechanism includes a solenoid having a solenoid pin, such that an activation of the solenoid causes the solenoid pin to extend to lock the door in the closed position or to retract to unlock the door. In a further example embodiment, the microcontroller is further for receiving a signal from the second sensor for opening the door. In yet a further example embodiment, the system further includes a rail above the door, and the gear assembly and motor are mounted on the rail. In one example embodiment, the microcontroller is also mounted on the rail. In another example embodiment, the system includes a rail and a bracket, and the gear assembly, the motor, and the microcontroller are mounted on the bracket which is mounted on the rail. In yet another example embodiment, the motor is a variable speed or a variable torque motor. In a further example embodiment, the system further includes a planetary gear box driven by the motor such that the first gear is driven by the planetary gear box.

In another example embodiment a touchless stall door opening and closing system for a plurality of stalls is provided. For each stall the system includes a motor, a door pivot for pivoting the door between an open position and a closed position, and a gear assembly including, a first gear coupled to the motor, and a second gear for driving the door pivot and coupled to the first gear. The motor is for driving the first gear which drives the second gear for driving the door pivot for opening and closing a door. The system also includes a locking mechanism for locking the door when the door is in the closed position, a first sensor, a second sensor, and a microcontroller for receiving a signal from the first sensor to drive the motor for opening the door and for receiving a signal from the second sensor for actuating the locking mechanism for unlocking the door. In one example embodiment, the first gear and the second gear are bevel gears, and the first gear rotates about a first axis and the second gear rotates about a second axis perpendicular to the first axis. In another example embodiment, the system further includes a dampener coupled to the door pivot. In yet another example embodiment, the locking mechanism includes a solenoid having a solenoid pin, wherein activation of the solenoid causes the solenoid pin to extend to lock the door in the closed position or retract to unlock the door. In a further example embodiment, the microcontroller is also for receiving a signal from the second sensor for opening the door. In yet a further example embodiment, the system also includes a rail above the door, and the gear assembly and the motor are mounted on the rail. In one example embodiment, the microcontroller is mounted on the rail. In another example embodiment, the system includes a rail and a bracket, and the gear assembly, the motor and the microcontroller are mounted on the bracket which is mounted on the rail. In yet another example embodiment, the motor includes is a variable speed or a variable torque motor. In a further example embodiment, the system also includes a central controller for receiving information from each microcontroller relating to the number of times the door was opened, closed or locked. In yet a further example embodiment, the central controller receives the information from each microcontroller wirelessly. In another example embodiment, the system further includes a central controller for providing appropriate signals for opening, closing or locking any of the doors. In yet another example embodiment, the system further includes a planetary gear box driven by the motor, such that the first gear is driven by the planetary gear box.

In an example embodiment a method for touchless operation of a door is provided. The method includes touchless sensing of a person outside of the door, touchless opening of the door in response to the sensing, touchless closing of the door after a predetermined time from the opening, touchless locking of the door, touchless sensing of the person inside of the door, touchless unlocking of the door in response to the sensing the person inside the door, and touchless opening of the door. In another example embodiment, touchless sensing occurs using a sensor, and touchless closing of the door occurs after a predetermined period of time has passed after touchless opening of the door, or after touchless sensing by another sensor of the person inside of the door. In yet another example embodiment, touchless opening the door includes opening the door using a torque applied by a motor, the method further includes varying the torque applied by the motor.

In a further example embodiment, a method for touchless operation of a door of a plurality of doors providing entrance to a plurality of stalls is provided. The method includes sensing a person outside of a door of a stall of the plurality of stalls, touchless opening of the door in response to the sensing, touchless closing of the door after a predetermined time from the opening, touchless locking of the door, touchless sensing of the person inside the stall, touchless unlocking of the door in response to the sensing the person inside the door, and touchless opening of the door. In one example embodiment, touchless sensing occurs using a sensor, and touchless closing of the door occurs after a predetermined period of time has passed after touchless opening of the door, or after touchless sensing by another sensor of the person inside of the door. In another example embodiment, touchless opening of the door includes opening the door using a torque applied by a motor, the method further includes varying the torque applied by the motor. In yet another example embodiment, the method further includes sending a signal to open all or any one of the doors of the plurality of doors. In a further example embodiment, the method also includes sending a signal to unlock all or any one of the doors of the plurality of doors. In yet a further example embodiment, the method also includes monitoring the number of times each door of the plurality of doors opens, closes or locks.

### BRIEF DESCRIPTION OF THE DRAWINGS

FIG. 1 is a top view of an example embodiment bathroom having multiple stalls incorporating example embodiment touchless door open/close systems.

FIG. 2 is partial plan view of an upper portion of a stall shown in FIG. 1. incorporating an example embodiment touchless door open/close system.

FIG. 3 is a cross-sectional view of a motor and gear assembly incorporated in an example embodiment touchless door open/close system.

FIG. 4 is a side end view of a stall incorporating an example embodiment touchless door open/close system.

FIG. 5 is a schematic of an example embodiment touchless door open/close system.

FIG. 6 is a partial perspective view of an example embodiment planetary gear box.

### DESCRIPTION

Since germs are very likely to be found in a commercial bathroom stall, the system is described herein by way of example for a bathroom stall and more specifically for a commercial bathroom having multiple bathroom stalls.

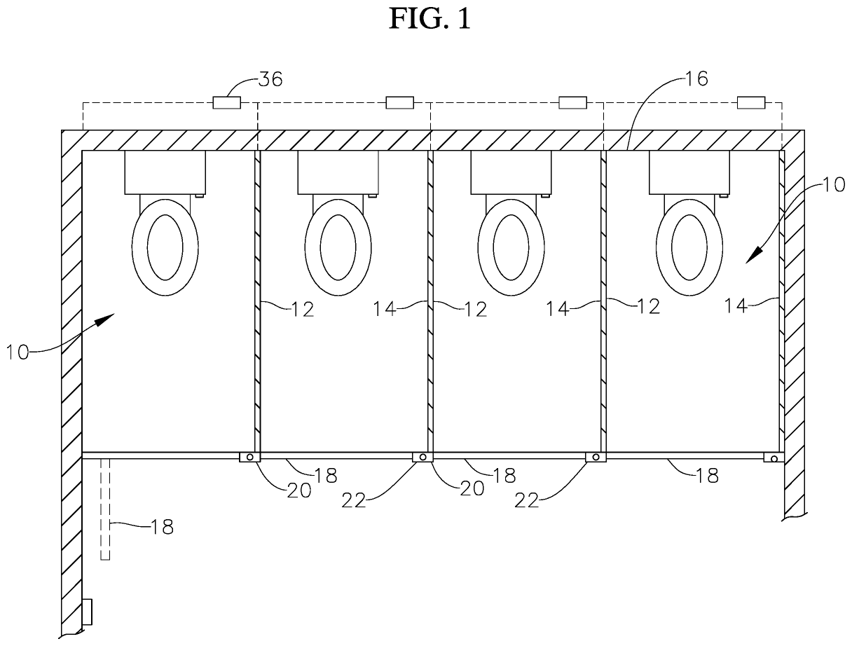

A commercial bathroom includes multiple bathroom stalls 10 in series as for example shown in FIG. 1. Each bathroom stall typically includes first and second opposite side walls 12, 14, and a rear wall 16 extending between the two side walls. A door 18 rotates relative to a first 20 stile coupled to the front of the first side wall. The door pivots between on open position allowing for entry and exit from the stall and closes against a second stile 22 coupled to the front of the second side wall. In some embodiments the stiles may be omitted and the door is otherwise hingeably coupled relative first side wall and closes against a front end portion of the second sidewall. The second stile of one stall may also serve as the first stile of an adjacent stall.

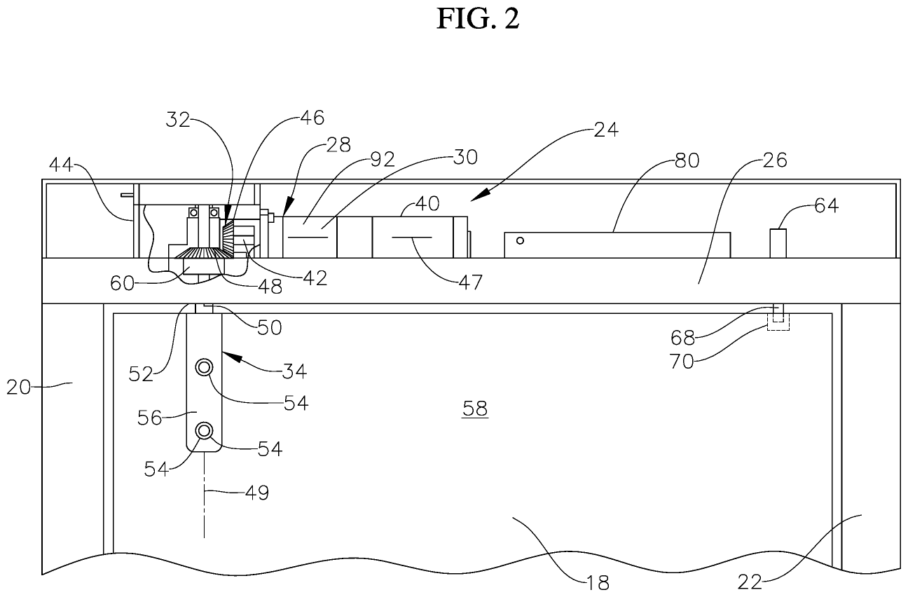

In an example embodiment, each stall in the bathroom is provided with a system 24 for touchless opening, closing and locking of the door, as for example shown in FIG. 2. In an example embodiment, a rail 26 extends along the front of the stall above the door and stiles and extends from the first stile 20 to the second stile 22. In an embodiment where stiles are not incorporated, the rail extends from the first side wall to the second side wall. The example embodiment described herein includes the stiles. A mechanism 28 for opening and closing the door is mounted on the rail. The mechanism includes a motor 30, a gear assembly 32, and a door pivot 34.

The motor is an electric motor. It may be battery operated or hardwired to an electricity source. In an example embodiment, the motor is a 24-volt motor powered by a volt supply unit 36. In an example embodiment, the motor is a variable torque and/or speed motor that can be varied for providing sufficient driving force for opening and/or closing doors of different sizes and weights. A motor controller 38 controls the on and off operation of the motor. The motor includes a housing 40. A drive shaft 42 is driven by the motor and extends beyond the motor housing 40. The housing is fixed relative to the rail 26. In example embodiment the gear assembly is housed within a gear box 44. The motor 30 in an example embodiment may be mounted to the gear box and the gear box is mounted on the rail. In another example embodiment, the motor may be directly mounted on the rail. In an example embodiment, the gear assembly includes two bevel gears. A first bevel gear 46 is driven by the drive shaft 42 of the motor 30 about a horizontal axis 47 extending along the rail. The second bevel gear 48 is driven by the first bevel gear about a vertical axis 49 perpendicular to the horizontal axis 47. In an example embodiment the gear ratio between the first and second bevel gears is 2:1.

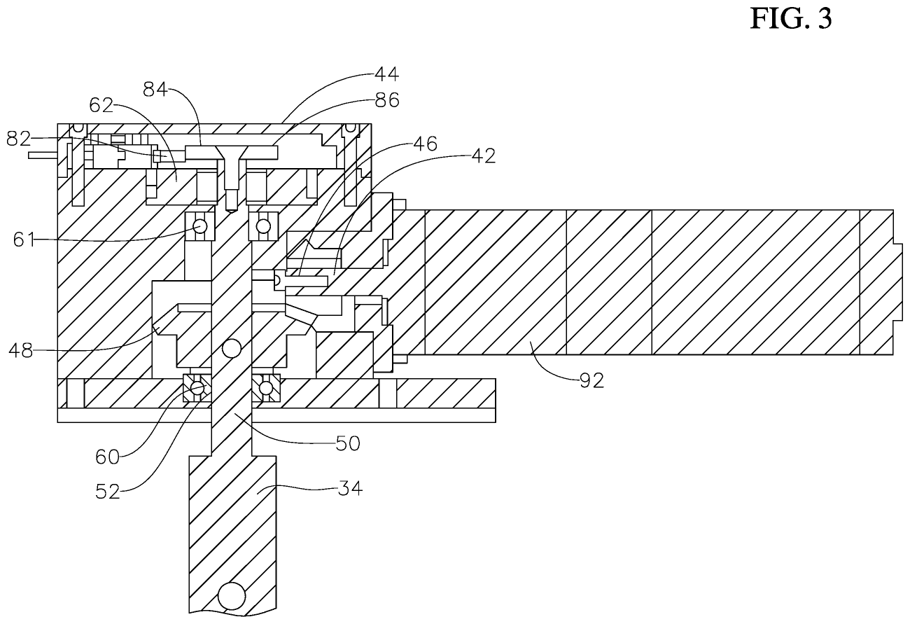

As shown in FIGS. 2 and 3, the door pivot 34 is driven by the second bevel gear 48. The door pivot extends along the vertical axis of rotation 49 of the second bevel gear such that as the second bevel gear rotates so does the door pivot about the vertical axis of rotation 49 of the second bevel gear. In example embodiment, the door pivot is connected to the second bevel gear by a pivot shaft 50 extending along axis 49. The door pivot shaft penetrates an opening 52 on the rail and the door pivot is coupled to the door. The door pivot may have a square or rectangular cross-sectional end portion that is fitted in an opening on the door, having a complementary cross-section, extending from an upper end of the door. In other example embodiments, the pivot is fastened to the door with fasteners 54. For example, the door pivot has a face 56 that extends over the inner or outer surface 58 of the door and it is fastened thereto. In another example embodiment, the door pivot defines channel for receiving an upper end of the door. In an example embodiment, the pivot shaft 50 penetrates the gear box and rotates relative to the gear box on a bearing 60. In an example embodiment two spaced apart bearings 60, 61 are used. In an example embodiment, a dampener 62, such as a rotation dampener, is used to alleviate or dampen the drive backlash that may occur from the gear assembly powered by the motor when the assembly is actuated to open the door.

A second door pivot (not shown) is mounted on the floor for rotation about the vertical axis 49 of rotation. In an example embodiment, when mounted on the floor, the second pivot freely rotates relative to the floor. The second door pivot may couple with the lower end of the door in the same way as the door pivot 34 is coupled with the upper end of the door. The door opens and closes by pivoting about the first and second door pivots.

A solenoid 64 is provided for locking the door 18 in a closed position. In the example embodiment, the solenoid 64 is mounted on the rail 26. The solenoid includes a pin 68 such that when actuated, the pin penetrates the rail and extends into an opening or recess 70 at the top of the door. In other example embodiments, the solenoid may be mounted in other locations as for example within one of the stiles, or within a doorframe in embodiments where a door frame may be incorporated. When actuated the solenoid pin extends from the stile and/or doorframe and into the door locking it in the closed position. After being actuated, another actuation of the solenoid causes the pin to retract within the solenoid and thus, unlock the door. In another example embodiment, the solenoid is spring loaded in the retracted position. As such to activate for locking the door, power is sent to the solenoid from an electric power source causing the solenoid pin to extend against a spring force to lock the door. Withdrawing of the solenoid pin can occur by removing power from the solenoid (i.e., de-actuating the solenoid). Thus, to unlock the door a signal is sent to remove power going to the solenoid. In this regard, in case of a power failure, the solenoid will retract to the unlocked position so that the door will be unlocked. In an example, the solenoid may receive power from the volt supply unit 36 or from another power source. In an example embodiment, the solenoid may be battery operated.

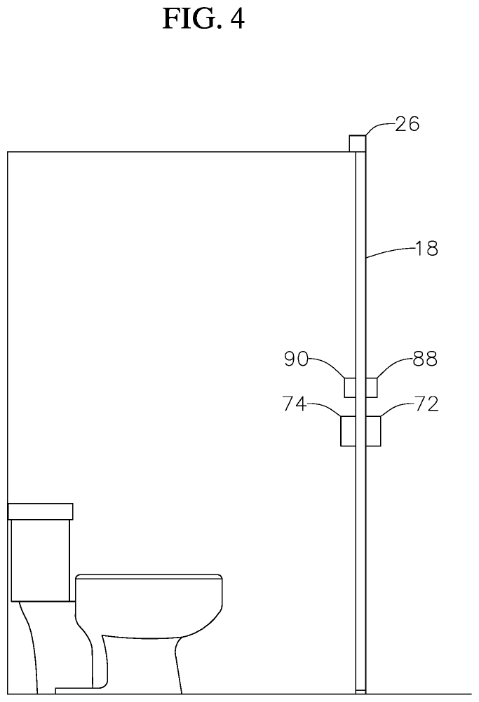

As shown in FIG. 4, an open/entry sensor (“open sensor”) 72 is provided on the external surface the door or at a stile adjacent the door. A close/lock/exit sensor (“close sensor”) 74 is provided on the inner surface of the door or on an inner surface of a stile adjacent the door. The sensors are in example embodiments placed at heights as directed by ADA requirements. In an example embodiment, the sensors are located on the stiles furthest from the axis of rotation of the door (i.e. the vertical axis of rotation 49) at a height of where a door handle would typically be and in accordance with ADA requirements. In an example embodiment, both sensors are close proximity infrared sensors. Other sensors that are capable of detecting an object within a desired sensor zone may be used.

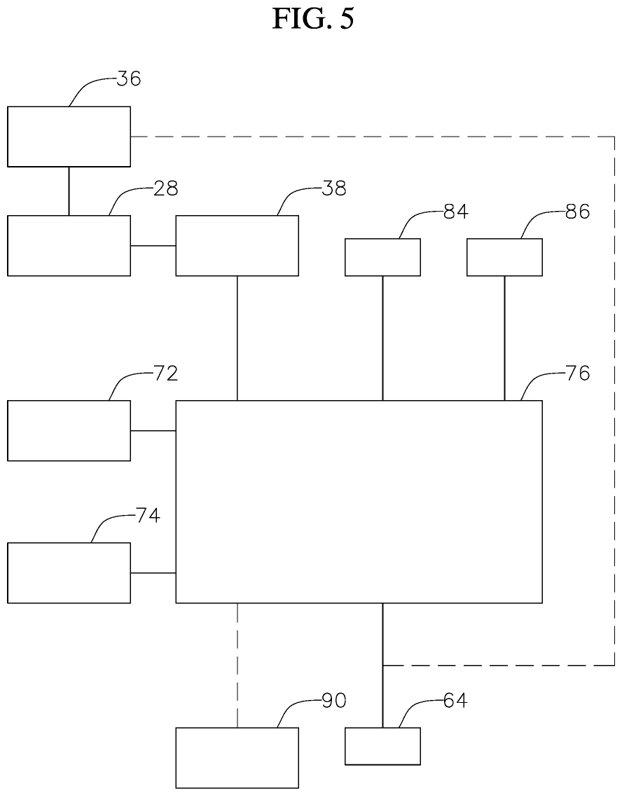

A microcontroller 76 is provided and in an example embodiment it is also mounted on the rail. In an exemplary embodiment the microcontroller is an ESP32 processor. In an example embodiment, the microcontroller 76 and the motor controller 38 are housed in an electronics package 80 mounted on the rail. The microcontroller communicates with the two sensors 72, 74 as well as with the motor controller 38 and the solenoid 64 (FIG. 5).

In an example embodiment the motor with motor housing, the gear box including the gear assembly, the motor controller and the microcontroller are mounted on a bracket defining a preformed assembly and the bracket is then mounted on the rail. In a further example embodiment, the solenoid is also mounted on the bracket.

To open the door, a user moves (e.g. hovers) their hand or other object in close proximity to the open sensor 72. Once the open sensor senses the hand movement it sends a signal to microcontroller 76 which in turn sends a signal to the motor controller 38 to turn the motor 28 on to drive the door pivot 34 causing the door to open a predetermined amount. The door will close after a user waves (e.g., hovers) their hand or other object in front of the close sensor, which causes the sensor to send a signal to the microcontroller 76 which in turn sends a signal to the motor controller 38 to turn on the motor 28 to drive the door pivot 34 causing the door to close. In another example embodiment, the door, after it is opened, will close after a predetermined period of time, even without the user waving their hand or other object in front of the close sensor 74. The user, then can wave their hand or other object in front of the close sensor 74 causing the close sensor to send a signal to the microcontroller 76 which then sends a signal to activate (e.g., actuate) the solenoid 64 causing the solenoid pin 68 to enter the door opening or recess 70 and to lock the door in place. To open the door a user holds or waves his hand or other object in front of the close sensor for a predetermined period of time at which time the close sensor will send a signal to the microcontroller which in turns sends a signal to activate (e.g., actuate or de-actuate) the solenoid to retract the solenoid pin 68 from the opening or recess 70 to unlock the door, and subsequently to the motor controller 38 to operate the motor in reverse to open the door. In alternate exemplary embodiments the motor rotates in the same direction to open and close the door and incorporates appropriate gearing for opening and closing the door. After the door is opened, in an example embodiment, the door will close again after a predetermined period of time.

The sensors are such that in an exemplary embodiment they are activated when someone waves or places an object like their hand for a predetermined time in close proximity to the sensor and/or removes such object from the close proximity to the sensor. In this regard the sensors cannot get inadvertently activated and cause the door to open or unlock when a person is passing by the sensor or is sitting on the toilet within the stall. In an example embodiment, the sensors have adjustable sensitivity so that their sensitivity can be adjusted and such that the reach of their sensing zone within which they can detect an object can be controlled.

As shown in FIG. 3, in an example embodiment, a micro switch cam 82 may be provided coupled to the gear box 44. Two micro-switches 84, 86 are coupled to the door pivot shaft 50. In an alternate example embodiment, the micro-switch cam is mounted on the door pivot shaft and the two micro-switches are coupled to the gear box. As the door opens, the cam engages the first micro-switch 84 which send a signal to the micro-controller 76 which sends a signal to the motor controller 38 to stop the motor and the further opening of the door. When the door is sufficiently closed, the cam 84 engages the second micro switch 86 which sends a signal to the micro-controller which sends a signal to the motor controller to stop the motor and the further closing of the door. In other example embodiments, the amount the door closes and opens can be controlled by the microcontroller or using a timer that would allow the motor to run for a predetermined amount of time to open the door and for a predetermined amount of time to close the door. In other example embodiments, an optical switch may be used which directly or indirectly communicates with the motor controller to control the amount the door opens and closes. In addition, the opening and/or closing speed of the door can be adjusted or set on site by using a potentiometer or a DIP switch that controls the amount of power provided to the motor.

In exemplary embodiment indicators 88, 90 may be provided at or proximate the open and close sensors 72, 74, respectively to indicate whether the stall is occupied and the door is locked, whether the stall is available. The indicators may be lights of different color or a single light that is capable of changing color. In other example embodiments, the indicators may be displayed signs or digital signs.

To open the door, a user waves or places, as for example hovers, his hand in front of the open sensor and in close proximity to the open sensor for a predetermined time and the open sensor generates the appropriate signal which is sent to the micro-controller. Instead of his/her hand, a user may wave or place a different part of his body or object over and in close proximity to the open sensor. For illustrative purposes, the operation herein is described with using a user's hand to activate the system. In an example embodiment, the outside indicator 88 indicates that the stall is available for use. If a light is used, the light may be green. Alternative a display displays an indication such as “open” or “available” to indicates that the stall is available for occupancy. Once the door is opened, the door in an example embodiment will close automatically after a timed period unless a user waves or places (e.g., hovers) their hand over and in close proximity to the close sensor which would cause the close sensor to send a signal to the micro-controller to close the door and to lock the door by activating the solenoid. If the door closes after the predetermined time without the user waving or placing (e.g., hovering) their hand over and in proximity to the close sensor, the door is locked once the user waves or places their hand over and in close proximity to the sensor. In other example embodiments, the door locks by activating the solenoid automatically when the door closes after it has opened by a person waving or placing their hand by the open sensor. When the door is locked, in an example embodiment, the indicators inside and outside the stall, may illuminate in red, if they are light indicators, and if display indicators, the indicator may display that the stall is locked or occupied. If light indicators are used, while the door is in the process of being locked, the indicators in an example embodiment, may blink in red light.

To exit the stall, the user waves or places their hand over and in close proximity to the close sensor located inside the stall. This causes the close sensor to send a signal to the micro-controller which sends a signal to the solenoid to unlock the door and to the motor controller to drive the motor to open the door. At this point, in an example embodiment, the indicators turn green or otherwise indicate the stall is available.

In an example embodiment, the sensors alone or in combination with their corresponding indicators are manufactured in sealed units and are thus, washable. In an example embodiment, if the door is forced open by the user, the gear assembly will allow the door to be opened manually, albeit slowly. In an exemplary embodiment, the door will feel sluggish and resistant to the push. The system is such that if the door is open, the user can enter and close it by placing or waving his hand in the close sensor.

In example embodiments, the sensors communicate with the microcontrollers wirelessly or via wires. Wireless communication as used herein refers to any available wireless communication using any wireless communication technology, as for example Bluetooth or Wi-Fi. In other example embodiment, the microcontroller may communicate the motor controller and/or the solenoid lock wirelessly or via wires. In an example embodiment, the micro-controller may communicate wirelessly or via wires with central controller 90 as shown in FIG. 5, providing information as to the number of times the doors have opened and closed. The central controller may be used to determine proper maintenance cycles for each system based on use. The central controller may also be used to unlock any stall door by activating the solenoid in case the system otherwise fails. The controller may also shut power to the systems allowing solenoid pins 68 to disengage and thus, allowing the doors to open by manually being pushed open. The central controller can also be used to send appropriate signals to open, close or lock any one or all of the doors in an example embodiment system. The central controller may be used to communicate or display directly or indirectly the number of unoccupied stalls to a location outside the bathroom. The central controller may also be used to control the opening/closing speed of any door or all of the doors by controlling the amount of power provided to the motor of each of such doors, as for example by controlling a potentiometer used to control the power input to such motor.

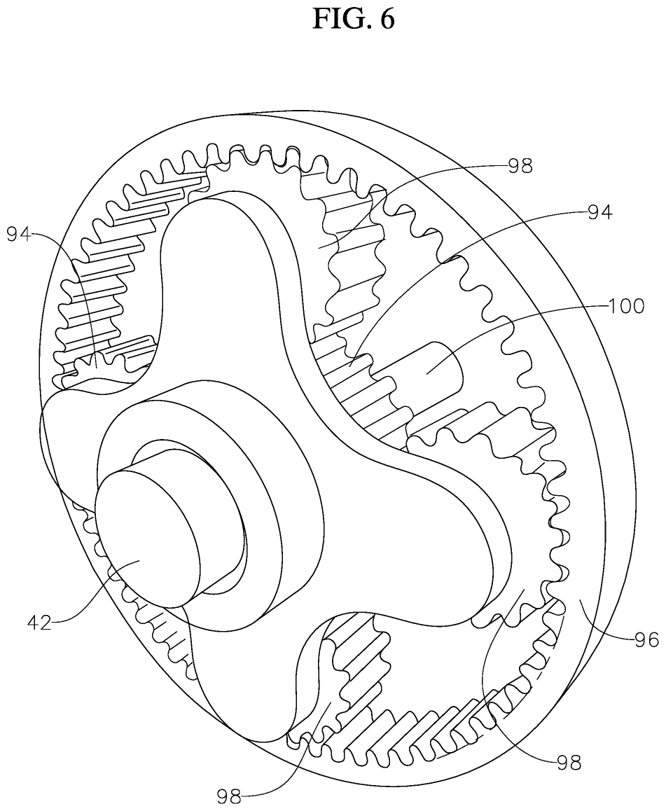

In further example embodiment, a planetary gear box (also known as an epicyclic gear train) 92 (FIGS. 1, 3 and 6) may be incorporated for being driven by the motor 30. A planetary gear box includes a sun gear 94, an outer gear ring 96, and a plurality of planet gears 98 meshed with the sun gear and the outer gear ring as for example shown in FIG. 6. With this example embodiment, the drive shaft 42 is driven by the planetary gear box planet gears 98 and the motor 30 drives the sun gear 94 via an input shaft 100. Planetary gear boxes are well known in the art and are described in detail for example in https://en.wikipedia.org/wiki/Epicyclic_gearing the contents of which are fully incorporated herein by reference. The planetary gear box provides for torque control and speed reduction when powered. An exemplary planetary gear box provides a 2900 RPM to 21 RPM ratio. It also allows the motor to “back wind” when not powered. As such, the planetary gear allows the door to be opened manually as the motor can be back wound.

While this invention has been described in detail with particular references to embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention. Although relative terms such as “inner,” “outer,” “upper,” “lower,” and similar terms have been used herein to describe a spatial relationship of one element to another, it is understood that these terms are intended to encompass different orientations of the various elements and components of the invention in addition to the orientation depicted in the figures. Additionally, as used herein, the term “substantially” and similar terms are used as terms of approximation and not as terms of degree, and are intended to account for the inherent deviations in measured or calculated values that would be recognized by those of ordinary skill in the art. Furthermore, as used herein, when a component is referred to as being “attached to” or “coupled to” another component, it can be directly coupled or attached to the other component or intervening components may be present therebetween, unless expressly stated otherwise.

1. A touchless stall door opening and closing system comprising:
a motor;
a door pivot for pivoting a door between an open position and a closed position;
a gear assembly comprising,
a first gear coupled to the motor, and
a second gear for rotating the door pivot about a door pivot axis and coupled to the first gear, wherein the motor is for driving the first gear which drives the second gear to rotate about the door pivot axis for rotating the door pivot about the door pivot axis for opening and/or closing a door;
a locking mechanism for locking the door when the door is in the closed position;
a first sensor;
a second sensor; and
a microcontroller for receiving a signal from the first sensor to drive the motor for opening the door and for receiving a signal from the second sensor for actuating the locking mechanism for unlocking the door.

2. The system as recited in claim 1, wherein the first gear and the second gear are bevel gears, wherein the first gear rotates about a first axis, wherein the door pivot axis about which the second gear rotates is perpendicular to the first axis.

3. The system as recited in claim 1, further comprising a dampener coupled to the door pivot.

4. The system as recited in claim 1, wherein the locking mechanism comprises a solenoid having a solenoid pin, wherein activation of the solenoid causes the solenoid pin to extend to lock the door in the closed position or retract to unlock the door.

5. The system as recited in claim 1, wherein the microcontroller is further for receiving a signal from the second sensor for opening the door.

6. The system as recited in any claim 1, further comprising a rail above the door, wherein the gear assembly and the motor are mounted on said rail.

7. The system as recited in claim 6, wherein the microcontroller is mounted on the rail.

8. The system as recited in claim 1, further comprising a rail and a bracket, wherein the gear assembly, the motor, and the microcontroller are mounted on the bracket which is mounted on the rail.

9. The system as recited in claim 1, wherein the motor is at least one of a variable speed and a variable torque motor.

10. The system as recited in claim 1, further comprising a planetary gear box driven by the motor, wherein the first gear is driven by the planetary gear box.

11. A touchless stall door opening and closing system for a plurality of stalls, for each stall the system comprising:
a motor;
a door pivot for pivoting the door between an open position and a closed position;
a gear assembly comprising,
a first gear coupled to the motor, and
a second gear for rotating the door pivot about a door pivot axis and coupled to the first gear, wherein the motor is for driving the first gear which rotates the second gear about the door pivot axis for rotating the door pivot about the door pivot axis for opening and/or closing a door;
a locking mechanism for locking the door when the door is in the closed position;
a first sensor;
a second sensor; and
a microcontroller for receiving a signal from the first sensor to drive the motor for opening the door and for receiving a signal from the second sensor for actuating the locking mechanism for unlocking the door.

12. The system as recited in claim 11, wherein the first gear and the second gear are bevel gears, wherein the first gear rotates about a first axis, wherein the door pivot axis about which the second gear rotates is perpendicular to the first axis.

13. The system as recited in claim 11, further comprising a dampener coupled to the door pivot.

14. The system as recited in claim 11, wherein the locking mechanism comprises a solenoid having a solenoid pin, wherein activation of the solenoid causes the solenoid pin to extend to lock the door in the closed position or retract to unlock the door.

15. The system as recited in claim 11, wherein the microcontroller is further for receiving a signal from the second sensor for opening the door.

16. The system as recited in claim 11, further comprising a rail above the door, wherein the gear assembly and the motor are mounted on said rail.

17. The system as recited in claim 15, wherein the microcontroller is mounted on the rail.

18. The system as recited in claim 11, further comprising a rail and a bracket, wherein the gear assembly, the motor and the microcontroller are mounted on the bracket which is mounted on the rail.

19. The system as recited in claim 11, wherein the motor is at least one of a variable speed and a variable torque motor.

20. The system as recited in claim 11, further comprising a central controller for receiving information from each microcontroller relating to the number of times the door was opened, closed or locked.

21. The system as recited in claim 20, wherein the central controller receives said information from each microcontroller wirelessly.

22. The system as recited in claim 11, further comprising a central controller for providing appropriate signals for opening, closing or locking any of said doors.

23. The system as recited in claim 11, further comprising a planetary gear box driven by the motor, wherein the first gear is driven by the planetary gear box.

24. A method for touchless operation of a door comprising:
touchless sensing of a person outside of the door;
touchless opening of the door in response to said sensing;
automatic touchless closing of the door after a predetermined period of time has passed after touchless opening of said door;
touchless locking of the door;
touchless sensing of said person inside of the door;
touchless unlocking of the door in response to said sensing said person inside the door; and
touchless opening of the door.

25. The method as recited in claim 24, wherein touchless sensing occurs using a sensor.

26. The method as recited in claim 24, wherein touchless opening the door comprises opening the door using a torque applied by a motor, the method further comprising varying the torque applied by the motor.

27. A method for touchless operation of a door of a plurality of doors providing entrance to a plurality of stalls, the method comprising:
touchless sensing of a person outside of a door of a stall of the plurality of stalls;
touchless opening of the door in response to said sensing;
touchless closing of the door;
touchless locking of the door;
touchless sensing of said person inside the stall;
touchless unlocking of the door in response to said sensing said person inside the door;
touchless opening of the door; and
sending a signal to open any or a plurality of said plurality of doors.

28. The method as recited in claim 27, wherein touchless sensing occurs using a sensor, and wherein touchless closing of the door occurs after a predetermined period of time has passed after touchless opening of the door, or after touchless sensing by another sensor of the person inside of the door.

29. The method as recited in claim 27, wherein opening the door comprises touchless opening of the door using a torque applied by a motor, the method further comprises varying the torque applied by the motor.

30. (canceled)

31. The method as recited in claim 27, further comprising sending a signal to unlock all or any one of the doors of said plurality of doors.

32. The method as recited in claim 27, further comprising monitoring the number of times each door of said plurality of doors opens, closes or locks.
